(19) United States
(12) Patent Application Publication
(10) Pub. No.: US 2023/0161434 A1
(43) Pub. Date: May 25, 2023

(54) SELF CAPACITANCE ORTHOGONAL FREQUENCY DIVISION

(71) Applicant: Tactual Labs Co., New York, NY (US)

(72) Inventor: BRAON MOSELEY, Round Rock, TX (US)

(73) Assignee: Tactual Labs Co., New York, NY (US)

(21) Appl. No.: 17/917,466

(22) PCT Filed: Apr. 6, 2021
(86) PCT No.: PCT/US21/25878

§ 371 Date: Oct. 6, 2022

Related U.S. Application Data
(60) Provisional application No. 63/006,019, filed on Apr. 6, 2020.

(51) Int. Cl. G06F 3/041; H04J 11/00

(52) U.S. Cl. CPC G06F 3/04162; G06F 3/04166; G06F 3/04164; H04J 11/00; G06F 3/044

(57) ABSTRACT

A sensor has a transmitting input adapted to have a signal transmitted therethrough. The signal passes through at least one impedance component. A receiving end is additionally operably connected to the sensor. A sensor pad operably connected to the sensor is adapted to determine touch events proximate thereto. Touch events occurring proximate to the sensor pad are detected due to changes in a baseline impedance.

This application claims the benefit of U.S. Provisional Application Ser. No. 63/006,019 filed Apr. 6, 2020, the contents of which are hereby incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosed systems and methods relate in general to the field of sensing, and in particular to capacitive sensors using orthogonal frequency division multiplexing.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 is a diagram of a self capacitive sensor.

FIG. 2 is another diagram of a self capacitive sensor.

FIG. 3 is a graph showing a plot of magnitude and frequency for “high Q” implementations.

### DETAILED DESCRIPTION

The present application contemplates an improved sensing device implementing fast multi-touch sensing (FMT) chips. FMT chips are suited for use with frequency orthogonal signaling techniques (see, e.g., U.S. Pat. Nos. 9,019,224 and 9,529,476, and 9,811,214, all of which are hereby incorporated herein by reference). The sensor configurations and techniques discussed herein may be used with other signal techniques including scanning or time division techniques, and/or code division techniques. It is pertinent to note that the sensors described and illustrated herein are also suitable for use in connection with signal infusion (also referred to as signal injection) techniques and apparatuses.

The presently disclosed systems and methods involve principles related to and for designing, manufacturing and using optical based sensors, and particularly optical based sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. Applicants' capacitive based sensing implements the use of orthogonal signals. As such, and for further reference, this application incorporates by reference Applicants' prior U.S. Pat. No. 9,019,224, entitled “Low-Latency Touch Sensitive Device” and U.S. Pat. No. 9,158,411 entitled “Fast Multi-Touch Post Processing.” These applications contemplate FDM, CDM, or FDM/CDM hybrid touch sensors which may be used in connection with the presently disclosed sensors. In such sensors, interactions are sensed when a signal from a row conductor is coupled (increased) or decoupled (decreased) to a column conductor and the result received on that column conductor. By sequentially exciting the row conductors and measuring the coupling of the excitation signal at the column conductors, a heatmap reflecting capacitance changes, and thus proximity, can be created.

This application also employs principles used in fast multi-touch sensors and other interfaces disclosed in the following: U.S. Pat. Nos. 9,933,880; 9,019,224; 9,811,214; 9,804,721; 9,710,113; and 9,158,411. Familiarity with the disclosure, concepts and nomenclature within these patents is presumed. The entire disclosures of those patents and applications incorporated therein by reference are incorporated herein by reference. This application also employs principles used in fast multi-touch sensors and other interfaces disclosed in the following: U.S. patent application Ser. Nos. 15/162,240; 15/690,234; 15/195,675; 15/200,642; 15/821,677; 15/904,953; 15/905,465; 15/943,221; 62/540,458, 62/575,005, 62/621,117, 62/619,656 and PCT publication PCT/US2017/050547, familiarity with the disclosures, concepts and nomenclature therein is presumed. The entire disclosure of those applications and the applications incorporated therein by reference are incorporated herein by reference.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristics. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency orthogonal to each other, in which case, they could not be the same frequency.

Certain principles of a fast multi-touch (FMT) sensor have been disclosed in the patent applications discussed above. Orthogonal signals are transmitted into a plurality of transmitting conductors (or antennas) and the information received by receivers attached to a plurality of receiving conductors (or antennas), the signal is then analyzed by a signal processor to capacitively identify touch events. The transmitting conductors and receiving conductors may be organized in a variety of configurations, including, e.g., a matrix where the crossing points form nodes, and interactions are detected at those nodes by processing of the received signals. In an embodiment where the orthogonal signals are frequency orthogonal, spacing between the orthogonal frequencies, Δf, is at least the reciprocal of the measurement period τ, the measurement period τ being equal to the period during which the columns are sampled. Thus, in an embodiment, a column conductor or antenna may be measured for one millisecond (τ) using frequency spacing (Δf) of one kilohertz (i.e., Δf=1/τ).

In an embodiment, the signal processor of a mixed signal integrated circuit (or a downstream component or software) is adapted to determine at least one value representing each frequency orthogonal signal transmitted to a row. In an embodiment, the signal processor of the mixed signal integrated circuit (or a downstream component or software) performs a Fourier transform to received signals. In an embodiment, the mixed signal integrated circuit is adapted to digitize received signals. In an embodiment, the mixed signal integrated circuit (or a downstream component or software) is adapted to digitize received signals and perform a discrete Fourier transform (DFT) on the digitized information. In an embodiment, the mixed signal integrated circuit (or a downstream component or software) is adapted to digitize received signals and perform a Fast Fourier transform (FFT) on the digitized information—an FFT being one type of discrete Fourier transform.

It will be apparent to a person of skill in the art in view of this disclosure that a DFT, in essence, treats the sequence of digital samples (e.g., windows) taken during a sampling period (e.g., integration period) as though it repeats. As a consequence, signals that are not center frequencies (i.e., not integer multiples of the reciprocal of the integration period (which reciprocal defines the minimum frequency spacing)), may have relatively nominal, but unintended consequence of contributing small values into other DFT bins. Thus, it will also be apparent to a person of skill in the art in view of this disclosure that the term orthogonal as used herein is not “violated” by such small contributions. In other words, as we use the term frequency orthogonal herein, two signals are considered frequency orthogonal if substantially all of the contribution of one signal to the DFT bins is made to different DFT bins than substantially all of the contribution of the other signal.

For example, to achieve kHz sampling, for example, 4096 samples may be taken at 4.096 MHz. In such an embodiment, the integration period is 1 millisecond, which per the constraint that the frequency spacing should be greater than or equal to the reciprocal of the integration period provides a minimum frequency spacing of 1 KHz. (It will be apparent to one of skill in the art in view of this disclosure that taking 4096 samples at 4 MHz would yield an integration period slightly longer than a millisecond, and not achieve 1 kHz sampling, and a minimum frequency spacing of 976.5625 Hz.) In an embodiment, the frequency spacing is equal to the reciprocal of the integration period. In such an embodiment, the maximum frequency of a frequency orthogonal signal range should be less than 2 MHz. In such an embodiment, the practical maximum frequency of a frequency orthogonal signal range is preferably less than about 40% of the sampling rate, or about 1.6 MHz. In an embodiment, a DFT (which could be an FFT) is used to transform the digitized received signals into bins of information, each reflecting the frequency of a frequency orthogonal signal transmitted which may have been transmitted by the transmit antenna 130. In an embodiment 2048 bins correspond to frequencies from 1 KHz to about 2 MHz. It will be apparent to a person of skill in the art in view of this disclosure that these examples are simply that, exemplary. Depending on the needs of a system, and subject to the constraints described above, the sample rate may be increased or decreased, the integration period may be adjusted, the frequency range may be adjusted, etc.

In an embodiment, a DFT (which can be an FFT) output comprises a bin for each frequency orthogonal signal that is transmitted. In an embodiment, each DFT (which can be an FFT) bin comprises an in-phase (I) and quadrature (Q) component. In an embodiment, the sum of the squares of the I and Q components is used as a measure corresponding to signal strength for that bin. In an embodiment, the square root of the sum of the squares of the I and Q components is used as measure corresponding to signal strength for that bin. It will be apparent to a person of skill in the art in view of this disclosure that a measure corresponding to the signal strength for a bin could be used as a measure related to activity, touch events, etc. In other words, the measure corresponding to signal strength in a given bin would change as a result of some activity proximate to the sensors, such as a touch event.

The sensing apparatuses discussed above use transmitting and receiving antennas. However, it should be understood that whether the transmitting and receiving antennas are functioning as a transmitter of signals, a receiver of signals, or both depends on context and the embodiment. In an embodiment, the transmitting and receiving antennas for all or any combination of patterns are operatively connected to a single integrated circuit capable of transmitting and receiving the required signals. In an embodiment, the transmitters and receivers are each operatively connected to a different integrated circuit capable of transmitting and receiving the required signals, respectively. In an embodiment, the transmitting and receiving antennas for all or any combination of the patterns may be operatively connected to a group of integrated circuits, each capable of transmitting and receiving the required signals, and together sharing information necessary to such multiple IC configuration. In an embodiment, where the capacity of the integrated circuit (i.e., the number of transmit and receive channels) and the requirements of the patterns (i.e., the number of transmit and receive channels) permit, all of the transmitting and receiving antennas for all of the multiple patterns used by a controller are operated by a common integrated circuit, or by a group of integrated circuits that have communications therebetween. In an embodiment, where the number of channels requires the use of multiple integrated circuits, the information from each circuit is combined in a separate system.

In an embodiment, the mixed signal integrated circuit is adapted to generate one or more signals and transmit the signals to the transmitting antennas. In an embodiment, the mixed signal integrated circuit is adapted to generate a plurality of frequency orthogonal signals and send the plurality of frequency orthogonal signals to the transmitting antennas. In an embodiment, the mixed signal integrated circuit is adapted to generate a plurality of frequency orthogonal signals and one or more of the plurality of frequency orthogonal signals to each of a plurality of transmitting antennas. The frequency spacing between the frequency orthogonal signals should be greater than or equal to the reciprocal of the integration period (i.e., the sampling period).

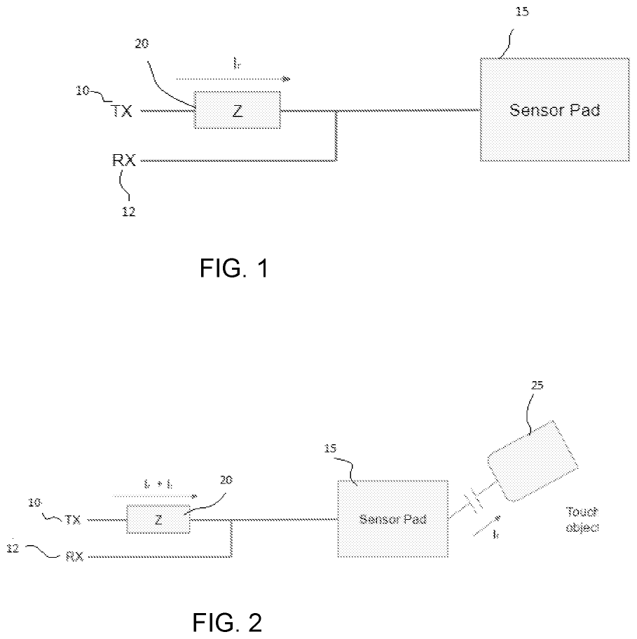

Using principles discussed above and applying them to different systems, and referring now to FIGS. 1 and 2, “self capacitance” is when a signal is transmitted and received on the same conductor or antenna. A signal is transmitted with a rise time to a conductor. The amount of signal that leaves and enters the output of the conductor is measured. The measurement of the output signal is performed multiple times. The information that is determined from the measured output signal is used in order to make a determination about whether or not that conductor was subjected to a touch event.

The touch object that approaches and contacts the conductor functions as another path to ground (i.e. earth) or small signal ground, and so in the presence of a touch object, the signal measured at the transmitting end of the conductor changes and the signal measured at the receiving end of the conductor changes. In an embodiment, the changes in signal at the transmitting end and the receiving end are different.

Referring to FIG. 1, the amount of signal loss from the transmission of signal from the transmitting end 10 to the receiving end 12 across a known impedance Z without the presence of a touch object near the sensor pad 15 may function as a “baseline” detection value for that sensor pad 15. The proximity of a touch object can also shunt current through an impedance component 20 and may increase the signal loss and by doing so reduce the amount of signal measured at the receiving conductor end 12. Signals that are frequency orthogonal can function in this “self capacitive” type of environment.

The impedance component 20 can be any component or mechanism that can alter the measurement of the signal. In an embodiment, the impedance component 20 is a resistor. In an embodiment, the impedance component 20 is a device that alters the electric field. In an embodiment, the impedance component 20 is a series of resistors. In an embodiment, the impedance component 20 is a series of components that alters the electrical field. In an embodiment, the impedance component 20 is an inductor.

When the impedance component 20 is a resistor, a variety of values, sizes and tolerances may be used for the resistor. Resistors are stable across a wide range of temperatures, currents, voltages, and frequencies.

When utilizing frequency orthogonal signals, in an embodiment a plurality of frequency orthogonal signals are transmitted from the transmitting end 10 through the impedance component 20 to the receiving end 12. Variations from an established baseline reading of received frequency orthogonal signals can be used to determine the presence of a touch object 25. The approach and contact of a touch object 25 with the sensor pad 15 will impact the signals received at the receiving end 12. Signals of different frequencies will exhibit a different result when a touch object 25 interacts with the sensor pad 15. Modeling the received frequencies and the manner in which different frequencies interact with touch objects and further facilitate determination of what is occurring on the sensor pad 15.

In an exemplary embodiment, the self-capacitance of the sensor pad 15 without a touch object 25 being present is 0.5 pF. When the proximity of a touch object 25 is approximately 3.0 cm from the sensor pad 15, the additional capacitance to “ground” is +0.05 pF. For a resistive impedance in the range of 1 mega-ohm, the I rms current into the transmitting input 10 without a touch object 25 at 100 khz and 1.0 V rms would be 239 nA rms, resulting in a V rms drop across the Z load of 239 mV rms, which is an easily detectable value.

The change in the I rms and the V rms drop with the addition of only +0.05 pF (50 femtofarads) is a delta I rms of +18 nA rms and a V rms delta of 18 mVrms. This is an easily detected value, especially when a 4096 sample FFT may be employed to integrate that delta across the sampling time.

In an exemplary embodiment, the impedance component 20 is a resistor, the impedance of a series inductor is jwL. For a 0603 sized inductor, the maximum usable inductance may be around 100 nH. At 100 nH, the impedance at 100 khz will be 6 milliohms. Because the changes in current being detected is small (on the order of nanoamps), the detectable V rms change across such a small Z might be undesirable.

At higher frequencies, the impedance at 100 Mhz of the same inductor (100 nH) is 62 ohms. However, any inductor in practice includes some complex package parasitics which cause it to act less like a pure inductor, so practical manufacturing conditions may be considered in a functional circuit. Interestingly, the impedance of sensor pad may also change with frequency as 1/jwC. The impedance of a 0.5 pF sensor pad at 100 Mhz is 3.18 kohms. Given a fixed L, and a fixed sensor pad 15 to environmental capacitance C, there is a point at which the impedance L is equal to the impedance of the C, resulting in the maximum I rms through the circuit.

For example, in an exemplary embodiment, as above, at 100 nH, 100 Mhz, and 0.5 pF, the total impedance is 62 ohms+3.18 kohms, resulting in I rms current at 1 V rms of 308 uA rms. As the frequency increases in this example, the impedance of the L will increase, the impedance of C will decrease, to the point of maximum I rms current through the circuit. This point occurs approximately at f=sqrt(1/(4pi**2LC))=>711 Mhz. At this point, the impedance of the inductor is about 446 ohms, and the impedance of the sensor pad 15 is about 446 ohms, resulting in an I rms current maximum at 1 V rms of 1118 uA rms, a factor of 3.6 times higher than current at 100 Mhz.

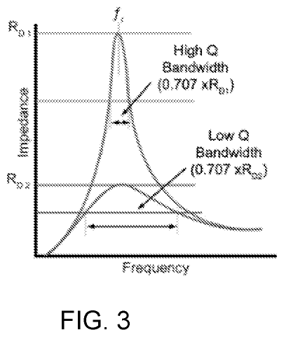

The physical properties of the inductor and the capacitor play on this relationship between L and C in their own package characteristics to create “high Q” versions of these inductors and capacitors that are tuned for certain frequency ranges. Using such types of physical implementations of devices (which include a complex arrangement of internally compensating L's and C's) the “peak” current at a certain frequency can be much much greater than that discussed above. FIG. 3 shows a sweep across frequency and a plot of magnitude and frequency for a “high Q” implementations.

In an embodiment of a sensing system that implements frequency orthogonal division, the peak Q of each sensor pad and inductive Z component is tested for and found at a particular frequency. For example, a frequency of bin N is presented to the fixed inductive Z, and the as yet to be determined sensor pad C. A signal measurement is made at the receiver. The frequency is increased at bin N+1, and a subsequent measurement of the signal is made. This process continues until the local minima amplitude at a frequency is found (maximum loss=>maximum I rms across the fixed inductive Z). At this point, any perturbation of the sensor pad C (i.e. alteration with respect to a newly presented touch object) would result in a shift in the Q point of the circuit, and the signal would be readily detected as a positive delta at the receiver.

Additionally, a tracking algorithm can be implemented where the frequency is continually adjusted in the presence of a touch object in an attempt to “retune” and maintain the frequency at the local minima point. The drift in frequency from the “baseline” (no touch object) frequency condition to the touch object condition could alternatively be used to calculate the presence and magnitude of the touch delta.

In an embodiment, the impedance Z is modeled by a capacitor. In an embodiment, a fixed capacitor is chosen based on the order of the sensor pad to environment capacitance. Capacitors whose package and PCB SMT land and soldering capacitance is on the order of 1 pF or smaller are difficult and expensive to implement successfully in a practical form. Typically capacitance variation of part to part and across temperature can be held to +1-10% down to a capacitance of 10 pF. This means that the “fixed” capacitance Z may vary highly in the range of 1 pF or so.

When tiny capacitive values are needed, the PCB artwork itself can more effectively be employed to create a series or shunt capacitance on a line of a small particular value, with good tolerance board to board, and over temperature. Using such a “PCB artwork” technique, values down to less than 100 femtofarads can be generated with accuracy.

The capacitance C can be compared to the fixed R or L for providing additional capacitive capabilities. The board artwork can be used to create the capacitance. The peak I rms current can be found as with the inductive impedance to be the case where the fixed Z capacitance and the sensor pad capacitance are the same. In such a system, the frequency of operation is invariant (i.e. it doesn't matter what frequency it is operated at, the peak I rms current through the circuit will always be at a peak if the fixed Z capacitance and the sensor pad capacitance are identical). In an embodiment, the sensor pad capacitance is tuned to exactly match each fixed Z capacitance. In an embodiment, a frequency sweep technique (as used in the inductive) case is used to find the maximal I rms operating point.

Because both impedances are purely capacitive, the ratio of their impedances is fixed across frequency. In other words, the ratio of signal loss at the receiver is always the same amount, no matter which frequency is used, and the only thing which could alter the balance of this loss ratio would be the additional capacitance added to the environment by a touch object. In this case, a “tracking” feature can be implemented by modulating the amplitude of the transmit signal in order to keep the signal at the receiver at a constant value. In an embodiment, tracking with the Vpp of the transmitter is implemented.

In an embodiment, a self capacitive sensor has only one feedline operably connected to a sense pad. In an embodiment, feedlines are operably connected to only one side of a display. In an embodiment, feedlines are run from 4 sides separately minimizing bezel thickness all the way around. Based on the size of the sensor pad, hover based touch events can be determined at a greater distance. Because the capacitance a touch object shares with a sensor pad varies inversely with the distance between them, but varies proportionally to the area (i.e. the square of the aspect ratio), the larger the sensor pad, the greater the distance away one might conceivably detect a touch object. This additionally improves the “directivity” or “antenna gain” of the system as well by enabling easier access to location information further away from the sensor.

In an embodiment, a system has fewer pins because the “Z” is inside the ASIC (resistive or capacitive). In this embodiment, receivers are not externally located on the IC chip package, but connected internally.

Because there is no “crosstalk” component to this sensing modality, in an embodiment, the impedances are varied to produce ever more “sensitive” system designs. These impedances are under software control (via frequency, or ground plane reference, etc.). Tiny currents still produce big detectable voltages at higher impedance values.

In an embodiment, the self capacitive sensor is used for infusion. In an embodiment, the self capacitive sensor is used for pen ID. In an embodiment, the self capacitive sensor is used for stylus location. In an embodiment, the self capacitive sensor is used for the universal stylus initiative. In an embodiment, the self capacitive sensor is used for distance detection. In an embodiment, the self capacitive sensor is used for proximity detection. In an embodiment, the self capacitive sensor is used for phase detection versus amplitude detection.

An aspect of the disclosure is a sensing system comprising: a sensor pad; a transmitting input operably connected to the sensor pad, wherein the transmitting input is adapted to transmit a plurality of frequency orthogonal signals; a receiving end operably connected to the sensor pad, wherein the receiving end is adapted to receive at least one of the plurality of frequency orthogonal signals; an impedance component adapted to alter a measurement of signal at the receiving end, wherein a touch event is determined using, at least in part, measured received signal different from an established baseline measurement of signal.

Another aspect of the disclosure, is a method for determining a touch event comprising: establishing a baseline measurement of signal for a sensor system, wherein the sensor system comprises; a sensor pad; a transmitting input operably connected to the sensor pad, wherein the transmitting input is adapted to transmit a plurality of frequency orthogonal signals; a receiving end operably connected to the sensor pad, wherein the receiving end is adapted to receive transmitted frequency orthogonal signals; an impedance component, adapted to alter a measurement of signal at the receiving end, wherein a touch event is determined using, at least in part, measured received signal different from an established baseline measurement of signal; and determining a touch event when a measurement of a received signal is different than the baseline measurement of impedance.

While the invention has been particularly shown and described with reference to a preferred embodiment thereof, it will be understood by those skilled in the art that various changes in form and details may be made therein without departing from the spirit and scope of the invention.

1. A sensing system comprising:
a sensor pad;
a transmitting input operably connected to the sensor pad, wherein the transmitting input is adapted to transmit a plurality of frequency orthogonal signals;
a receiving end operably connected to the sensor pad, wherein the receiving end is adapted to receive at least one of the plurality of frequency orthogonal signals;
an impedance component adapted to alter a measurement of signal at the receiving end, wherein a touch event is determined using, at least in part, measured received signal different from an established baseline measurement of signal.

2. The sensing system of claim 1, wherein the impedance component is a resistor.

3. The sensing system of claim 1, wherein the impedance component is an inductor.

4. The sensing system of claim 1, wherein the impedance component is formed from a PCB board.

5. The sensing system of claim 1, wherein a baseline measurement of signal is established by transmitting a plurality of frequency orthogonal signals without the presence of a touch object.

6. The sensing system of claim 1, wherein the sensor pad is further adapted to infuse signal into a touch object.

7. The sensing system of claim 1, wherein the touch event determines distance of a touch object.

8. The sensing system of claim 1, wherein measured received signals comprise at least two signals frequency orthogonal with respect to each other.

9. The sensing system of claim 1, wherein the plurality of transmitted signals pass through the impedance component prior to interacting with the sensor pad.

10. The sensing system of claim 1, wherein the sensor pad is one of a plurality of sensor pads.

11. A method for determining a touch event comprising:
establishing a baseline measurement of signal for a sensor system, wherein the sensor system comprises;
a sensor pad;
a transmitting input operably connected to the sensor pad, wherein the transmitting input is adapted to transmit a plurality of frequency orthogonal signals;
a receiving end operably connected to the sensor pad, wherein the receiving end is adapted to receive transmitted frequency orthogonal signals;
an impedance component, adapted to alter a measurement of signal at the receiving end, wherein a touch event is determined using, at least in part, measured received signal different from an established baseline measurement of signal; and
determining a touch event when a measurement of a received signal is different than the baseline measurement of impedance.

12. The method of claim 11, wherein the impedance component is a resistor.

13. The method of claim 11, wherein the impedance component is an inductor.

14. The method of claim 11, wherein the impedance component is formed from a PCB board.

15. The method of claim 12, wherein the baseline measurement of signal is established by transmitting a plurality of frequency orthogonal signals without the presence of a touch object.

16. The method of claim 11, wherein the sensor pad is further adapted to infuse signal into a touch object.

17. The method of claim 11, wherein the touch event determines distance of a touch object.

18. The method of claim 11, wherein measured received signals comprise at least two signals frequency orthogonal with respect to each other.

19. The method of claim 11, wherein transmitted signals pass through the impedance component prior to interacting with the sensor pad.

20. The method of claim 11, wherein the sensor pad is one of a plurality of sensor pads.
